(19) United States
(12) Patent Application Publication
(10) Pub. No.: US 2024/0256946 A1
(43) Pub. Date: Aug. 1, 2024

(54) COMPUTER IMPLEMENTED METHOD FOR TRAINING A MODEL COMPRISING PLURALITY OF DATA SYNTHESIZERS FOR DATA SYNTHESIS WITH ENHANCED SCALABILITY AND A CORRESPONDING COMPUTER IMPLEMENTED METHOD FOR GENERATING A DATASET

(71) Applicant: YData Labs Inc, Seattle, WA (US)

(72) Inventors: Alexandre Quemy, Krakow (PL); Fabiana Martins Clemente, Seattle, WA (US)

(21) Appl. No.: 18/104,325

(22) Filed: Feb. 1, 2023

(51) Int. Cl. G06N 20/00

(52) U.S. Cl. CPC G06N 20/00

(57) ABSTRACT

The present disclosure relates to the area of automatic data generation, in particular data synthesis, defining a highly scalable methodology for data synthesis. The disclosure comprises a computer implemented method for training a model comprising plurality of data synthesizers for data synthesis. The method may in turn comprise:
providing a dataset X of M columns and N rows,
segmenting the N rows into segments of N/n rows, and slicing the M columns into slices of M/m columns,
combining each segment with a corresponding slice, thereby providing a providing a plurality of blocks, each block comprising a combination of a segment with a slice,
providing a model with K data synthesizers,
training each data synthesizer with a corresponding block,
   wherein a transformation is performed to provide statistical independence between rows and/or statistical independency between columns of the dataset X.

This method provides a substantially faster methodology, enabling a higher scalability.

### FIELD OF THE DISCLOSURE

The present disclosure relates to the area of automatic data generation, in particular data synthesis, defining a highly scalable methodology for data synthesis.

### PRIOR ART

Data synthesis relates to computer implemented methodologies in which an original dataset is used by the methodology, which learns how to generate a new dataset which is similar to the original dataset. This applicable methodology or model may be defined as a data synthesizer.

As referred, the object of the present disclosure involves scalability in data synthesis. Scalability may be defined as the time required to train a data synthesizer based on a dataset with M columns and N rows (thus, a dataset which can be represented in a tabular manner).

Solutions known in the art have a scalability or training time bottleneck in the number of columns of a used dataset, as each column may be depending on all others in a complex way that the applied data synthesizer has to discover and learn. For this reason, the complexity is often polynomial in M and/or N, leading to a high training time.

The presently disclosed solutions allow to turn the complexity associated with data synthesis into a linear complexity problem. This means that, for a dataset with k1×M′ columns and k2×N′ rows, the computational time to train the synthesizer becomes (k1×k2) the time to train a dataset of size M′xN′, where M′<M and N′<N and are arbitrarily fixed, considering the referred dataset with M columns and N rows and dependent columns.

Furthermore, this approach enables a parallel training of each block of M′×N′, thereby further reducing time complexity to a constant time in a number of parallel processors allocated to a training task.

The present solution thereby innovatively reduces the training time of data synthesizers, improving scalability.

### SUMMARY OF THE DISCLOSURE

The present disclosure comprises a computer implemented method for training a model comprising plurality of data synthesizers for data synthesis with enhanced scalability. The method may in turn comprise computationally performing the following steps:
providing a dataset X of M columns and N rows,
segmenting the N rows into segments of N/n rows, and slicing the M columns into slices of M/m columns,
combining each segment with a corresponding slice, thereby providing a providing a plurality of blocks, each block comprising a combination of a segment with a slice,
providing a model with K data synthesizers,
training each data synthesizer with a corresponding block,
   wherein a transformation is performed to provide statistical independence between rows and/or statistical independency between columns of the dataset X.

The computer implemented method for training a model of the present disclosure enables to break possible dependencies between columns such that instead of learning how to synthesize N columns with a single synthesizer, it can equivalently learn how to synthesize 1 column with N synthesizers.

This method thus overcomes prior art solutions by providing a linear training of a model with the number of columns. Thus, training n synthesizers—where n is an integer—with N/2 columns each is significantly faster than training 1 synthesizer with N columns. This method may thus be polynomially faster than methods known in the art.

In addition, since the synthesizers of the model are independent from each other, they can be trained in parallel.

The data synthesizers may be trained in parallel.

Each data synthesizer may be trained with a single corresponding block.

The transformation to provide statistical independence may comprise transforming the dataset X into a multivariate Gaussian distribution, thereby resulting in a normalized dataset X_n.

The computer implemented method for training a model may further comprise transforming the normalized dataset X_n such that it has identity covariance and zero mean.

Transforming the normalized dataset X_n such that it has identity covariance and zero mean may comprise applying a Principal Component Analysis (PCA) methodology to the normalized dataset X_n.

The transformation of the dataset X into the normalized dataset X_n may comprise applying a Normalizing Flow methodology to the dataset X.

Applying a Normalizing Flow methodology may comprise applying a Rotation-based Iterative Gaussianization methodology.

The present disclosure may further comprise a computer implemented method for generating a dataset X′ with enhanced scalability. The method for generating a dataset comprising:
training K data synthesizers according to the method for training of the present disclosure, from a provided original dataset X, and
correspondingly generate a new dataset X′.

Upon training of each data synthesizer, the computer implemented method for generating a dataset X′ may comprise:
sampling M records for each data synthesizer,
concatenating the K sample of M records to form a new dataset X′.

The computer implemented method for generating a dataset X′ may further comprise performing an inverted transformation to the dataset X′ regarding a transformation in which a dataset is transformed such that it has identity covariance and zero mean, thereby obtaining a transformed dataset X′_n.

Performing the inverted transformation to the dataset X′ regarding a transformation in which a dataset is transformed such that it has identity covariance and zero mean may comprise performing an inverted Principal Component Analysis (PCA) methodology.

The computer implemented method for generating a dataset X′ may further comprise performing an inverted transformation to the transformed dataset X′_n as regards a transformation to provide statistical independence between rows and/or statistical independence between columns.

Performing an inverted transformation to the transformed dataset X′_n as regards a transformation to provide statistical independence between rows and/or statistical independence between columns may comprise applying an inverted Normalizing Flow methodology.

Applying an inverted Normalizing Flow methodology may comprise optionally applying an inverted Rotation-based Iterative Gaussianization methodology.

The original dataset X may comprise any structured data and the new dataset X′ correspondingly comprises any structured data.

The present disclosure further comprises a computational apparatus or system. The computational apparatus or system may be configured to implement the computer implemented method for training a model, in any of its embodiments, or the computer implemented method for generating a dataset X′, in any of its embodiments.

The computational apparatus or system may:
be configured to train the data synthesizers in parallel, and
comprise a plurality of computational processors, optionally K computational processors, each computational processor being configured to train at least one data synthesizer in parallel with another computational processor which is configured to train at least one other data synthesizer.

### DESCRIPTION OF FIGURES

FIG. 1—representation of the computer implemented method for training a model comprising plurality of data synthesizers for data synthesis (100). The method (100) comprises:
providing a dataset X of M columns and N rows (110),
segmenting the N rows into segments of N/n rows, and slicing the M columns into slices of M/m columns (120), combining each segment with a corresponding slice, thereby providing a
providing a plurality of blocks, each block comprising a combination of a segment with a slice (130),
providing a model with K data synthesizers (140),
training each data synthesizer with a corresponding block (150),
   wherein a transformation is performed to provide statistical independence between rows and/or statistical independency between columns of the dataset X (200).

FIG. 2—representation of a slicing strategy according to the object of the present disclosure.

FIG. 3—representation of a segmentation strategy according to the object of the present disclosure.

FIG. 4—representation of a block strategy according to the object of the present disclosure.

### DETAILED DESCRIPTION

Several general aspects of the present disclosure are described in the Summary of the disclosure. Such aspects are detailed below in accordance with other advantageous and/or preferred embodiments of implementation.

The method may in turn comprise providing a dataset X of M columns and N rows and segmenting the N rows into segments of N/n rows, and slicing the M columns into slices of M/m columns. n and m are integers.

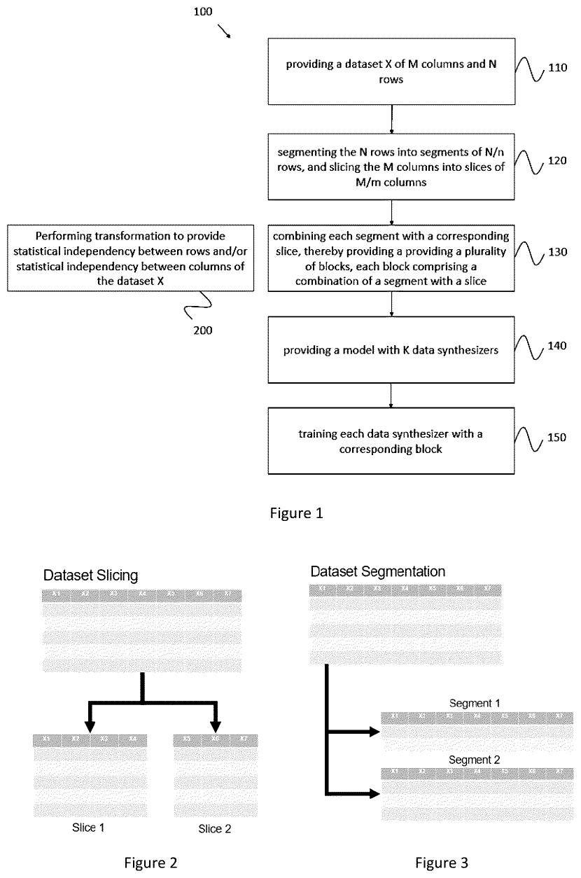

Segments and slices may be obtained according to a methodology known in the art. Such a methodology is represented in FIGS. 2-3.

The capacity of a model or corresponding synthesizer to scale depends on the number of rows (vertical scalability) and the number of columns (horizontal scalability) in the input dataset.

To handle horizontal scalability, it is possible to divide the rows into segments according to a certain policy and train a synthesizer per segment. Using subsampling, it is possible to ensure that there will be no loss of information about the overall correlation matrix which might affect the final synthetic dataset properties.

To handle vertical scalability, it is possible to divide the columns into slices and to train a synthesizer per slice. If the columns are not independent, the synthetic dataset does not provide for the best replication of the joint distribution between the slices.

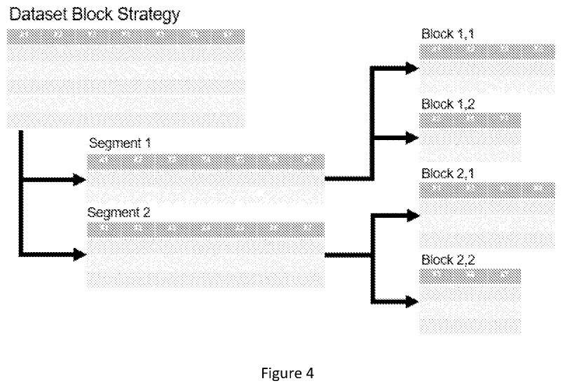

Slices and segments may be combined to provide blocks, according to a methodology known in the art. Such a methodology is represented in FIG. 4.

The segmentation strategy and the slice strategy thus lead to a block strategy. As referred, the input dataset X is broken down into blocks and for each block, a synthesizer instance may be trained. Because each block has a lower dimension and contains less data points, it can be drastically faster to train. In addition, each block being independent, the model/synthesizers can be trained in parallel.

By providing a model with K data synthesizers and the statistical independence between rows and/or statistical independence between columns of the dataset X, the present method is exponentially faster than prior art solutions since, e.g., training n synthesizers—where n is an integer—with N/2 columns each is significantly faster than training 1 synthesizer with N columns.

Data synthesizers may be trained in parallel, thereby providing an enhanced speed of training.

Each data synthesizer may be trained with a single corresponding block.

The transformation to provide statistical independence may comprise transforming the dataset X into a multivariate Gaussian distribution, thereby resulting in a normalized dataset X_n.

One property of a multivariate Gaussian is that if there is no correlation between columns, then the columns are independent.

As a multivariate Gaussian can easily be adjusted such that all components are uncorrelated, it easily leads to the component independence. Normalizing Flow algorithms are not used to estimate the distribution of the data but only turn it into a multivariate Gaussian.

The computer implemented method for training a model may further comprise transforming the normalized dataset X_n such that it has identity covariance and zero mean.

Transforming the normalized dataset X_n such that it has identity covariance and zero mean may comprise applying a Principal Component Analysis (PCA) methodology to the normalized dataset X_n.

The transformation of the dataset X into the normalized dataset X_n may comprise applying a Normalizing Flow methodology to the dataset X.

A Normalizing Flow is thus used to solve a problem of scalability.

Applying a Normalizing Flow methodology may comprise applying a Rotation-based Iterative Gaussianization methodology.

Rotation-based Iterative Gaussianization methodology is thereby also a methodology known in the art for purposes other than the present, reference being made to “Iterative Gaussianization: from ICA to Random Rotations”, V. Laparra, G. Camps and J. Malo, IEEE Transactions on Neural Networks, 2010 IEEE.

As referred, the present disclosure may further comprise a computer implemented method for generating a dataset X′.

The method for generating a dataset may comprise:
training K data synthesizers according to the method for training of any of the present disclosure, from a provided original dataset X, and
correspondingly generate a new dataset X′.

The original dataset X may comprise any structured data and the new dataset X′ correspondingly comprises any structured data, such as a table. These elements are, thereby, swiftly obtained through the method for generating a dataset of the present disclosure, as it involves using the method for training of the present disclosure.

Upon training of each data synthesizer, the computer implemented method for generating a dataset X′ may comprise:
sampling M records for each data synthesizer,
concatenating the K sample of M records to form a new dataset X′.

The computer implemented method for generating a dataset X′ may further comprise performing an inverted transformation to the dataset X′ regarding a transformation in which a dataset is transformed such that it has identity covariance and zero mean, thereby obtaining a transformed dataset X′_n.

Performing the inverted transformation to the dataset X′ regarding a transformation in which a dataset is transformed such that it has identity covariance and zero mean may comprise performing an inverted Principal Component Analysis (PCA) methodology.

The computer implemented method for generating a dataset X′ may further comprise performing an inverted transformation to the transformed dataset X′_n as regards a transformation to provide statistical independence between rows and/or statistical between columns.

Performing an inverted transformation to the transformed dataset X′_n as regards a transformation to provide statistical independence between rows and/or statistical independence between columns may comprise applying an inverted Normalizing Flow methodology.

Applying an inverted Normalizing Flow methodology may comprise optionally applying an inverted Rotation-based Iterative Gaussianization methodology.

The present disclosure further comprises a computational apparatus or system. The computational apparatus or system may be configured to implement the computer implemented method for training a model, in any of its embodiments, or the computer implemented method for generating a dataset X′, in any of its embodiments.

The computational apparatus or system may:
be configured to train the data synthesizers in parallel, and
comprise a plurality of computational processors, optionally K computational processors, each computational processor being configured to train at least one data synthesizer in parallel with another computational processor which is configured to train at least one other data synthesizer.

An embodiment of the method for training a model comprising plurality of data synthesizers for data synthesis of the present disclosure is subsequently described.

A dataset X with N columns is assumed, and an arbitrary synthesizer model is provided. The model is trained using the dataset X via a method fit and generates new data X′ via a method sample. The training method includes:
1. Learn the normalizing flow G that turns X into X_n which has a multivariate gaussian law
2. Transform X_n such that it has identity covariance and zero mean via a Principal Component Analysis (PCA). (at this stage the columns are independent)
3. Train K synthesizers (possibly in parallel) with some columns such that each of the N columns is trained by exactly one of the K synthesizer model sampling M new records
4. For each of the K synthesizers, sample M records (possibly in parallel)
5. Concatenate the K sample of M records to form a new dataset X′
6. Use on X′ the inverse of the PCA learned and applied in step 2. of the training process
7. Use on X′ the inverse of the normalizing flow G learned and applied in step 1. of the training process.

Further embodiments are subsequently defined, those embodiments being defined in terms of clauses, several clauses being defined with resort to the subject matter of previous clauses.

Clause 1. A method for training a model comprising plurality of data synthesizers for data synthesis with enhanced scalability, the method comprising computationally performing the following steps:
providing a dataset X of M columns and N rows,
segmenting the N rows into segments of N/n rows, and slicing the M columns into slices of M/m columns,
combining each segment with a corresponding slice, thereby providing a providing a plurality of blocks, each block comprising a combination of a segment with a slice,
providing a model with K data synthesizers,
training each data synthesizer with a corresponding block, wherein a transformation is performed to provide statistical independence between rows and/or statistical independency between columns of the dataset X.

Clause 2. A method according to the previous clause wherein the data synthesizers are trained in parallel.

Clause 3. A method according to any of the preceding clauses wherein each data synthesizer is trained with a single corresponding block.

Clause 4. A method according to any of the preceding clauses wherein the transformation to provide statistical independence comprises transforming the dataset X into a multivariate Gaussian distribution, thereby resulting in a normalized dataset X_n.

Clause 5. A method according to the previous clause wherein it further comprises transforming the normalized dataset X_n such that it has identity covariance and zero mean.

Clause 6. A method according to the previous clause wherein transforming the normalized dataset X_n such that it has identity covariance and zero mean comprises applying a Principal Component Analysis (PCA) methodology to the normalized dataset X_n.

Clause 7. A method according to any of the clauses 4-6 wherein the transformation of the dataset X into the normalized dataset X_n comprises applying a Normalizing Flow methodology to the dataset X.

Clause 8. A method according to the previous clause wherein applying a Normalizing Flow methodology comprises applying a Rotation-based Iterative Gaussianization methodology.

Clause 9. A computer implemented method for generating a dataset X′ with enhanced scalability comprising:
training K data synthesizers according to the method for training of any of the preceding clauses, from a provided original dataset X, and
correspondingly generating a new dataset X′.

Clause 10. A method according to the previous clauses wherein it further comprises, upon training of each data synthesizer:
sampling M records for each data synthesizer,
concatenating the K sample of M records to form a new dataset X′.

Clause 11. A method according to the previous clause wherein it further comprises performing an inverted transformation to the dataset X′ regarding a transformation in which a dataset is transformed such that it has identity covariance and zero mean, thereby obtaining a transformed dataset X′_n, optionally applying an inverted Principal Component Analysis (PCA) methodology.

Clause 12. A method according to the previous clause wherein it further comprises performing an inverted transformation to the transformed dataset X′_n as regards a transformation to provide statistical independence between rows and/or statistical independence between columns, optionally applying an inverted Normalizing Flow methodology, optionally applying an inverted Rotation-based Iterative Gaussianization methodology.

Clause 13. A computer implemented method according to any of the clauses 9-12 wherein the original dataset X may comprise any structured data and the new dataset X′ correspondingly comprises any structured data.

Clause 14. A computational apparatus or system configured to implement the method of any of the clauses 1-8 or the method of any of the clauses 9-13.

Clause 15. A computational apparatus or system according to the previous clause wherein the apparatus or system:
is configured to train the data synthesizers in parallel, and
comprises a plurality of computational processors, optionally K computational processors, each computational processor being configured to train at least one data synthesizer in parallel with another computational processor which is configured to train at least one other data synthesizer.

Although the present disclosure is mainly described in terms of methods and systems, the person skilled in the art understands that it is also directed to various devices or apparatuses.

The computational apparatus or system include components to perform at least some of the example features and features of the methods described, whether through hardware components (such as memory and/or processor), software or any combination thereof.

An article for use with the computational apparatus or system, such as a pre-recorded storage device or other similar computer-readable medium, including program instructions recorded on it, or a computer data signal carrying readable program instructions computer can direct a device to facilitate the implementation of the methods described herein. It is understood that such apparatus, articles of manufacture and computer data signals are also within the scope of the present disclosure.

A “computer-readable medium” means any medium that can store instructions for use or execution by a computer or other computing device, including read-only memory (ROM), erasable programmable read-only memory (EPROM) or flash memory, random access memory (RAM), a portable floppy disk, a drive hard drive (HDD), a solid state storage device (for example, NAND flash or synchronous dynamic RAM (SDRAM)), and/or an optical disc such as a Compact Disc (CD), Digital Versatile Disc (DVD) or Blu-Ray™ Disc.

As will be clear to one skilled in the art, the present disclosure should not be limited to the embodiments described herein, and a number of changes are possible which remain within the scope of the present disclosure.

Of course, the preferred embodiments shown above are combinable, in the different possible forms, being herein avoided the repetition of all such combinations.

1. A computer implemented method for training a model comprising plurality of data synthesizers for data synthesis with enhanced scalability, the method comprising computationally performing the following steps:
providing a dataset X of M columns and N rows,
segmenting the N rows into segments of N/n rows, and slicing the M columns into slices of M/m columns,
combining each segment with a corresponding slice, thereby providing a providing a plurality of blocks, each block comprising a combination of a segment with a slice,
providing a model with K data synthesizers,
training each data synthesizer with a corresponding block,
wherein a transformation is performed to provide statistical independence between rows and/or statistical independency between columns of the dataset X.

2. A method according to claim 1 wherein the data synthesizers are trained in parallel.

3. A method according to claim 1 wherein each data synthesizer is trained with a single corresponding block.

4. A method according to claim 1 wherein the transformation to provide statistical independence comprises transforming the dataset X into a multivariate Gaussian distribution, thereby resulting in a normalized dataset X_n.

5. A method according to claim 4 wherein it further comprises transforming the normalized dataset X_n such that it has identity covariance and zero mean.

6. A method according to claim 5 wherein transforming the normalized dataset X_n such that it has identity covariance and zero mean comprises applying a Principal Component Analysis (PCA) methodology to the normalized dataset X_n.

7. A method according to claim 4 wherein the transformation of the dataset X into the normalized dataset X_n comprises applying a Normalizing Flow methodology to the dataset X.

8. A method according to claim 7 wherein applying a Normalizing Flow methodology comprises applying a Rotation-based Iterative Gaussianization methodology.

9. A computer implemented method for generating a dataset X′ with enhanced scalability comprising:
training K data synthesizers, from a provided original dataset X, with a computer implemented method for training a model comprising plurality of data synthesizers for data synthesis with enhanced scalability, the method comprising computationally performing the following steps:
providing a dataset X of M columns and N rows,
segmenting the N rows into segments of N/n rows, and slicing the M columns into slices of M/m columns,
combining each segment with a corresponding slice, thereby providing a providing a plurality of blocks, each block comprising a combination of a segment with a slice,
providing a model with K data synthesizers,
training each data synthesizer with a corresponding block,
wherein a transformation is performed to provide statistical independence between rows and/or statistical independency between columns of the dataset X
and
correspondingly generating a new dataset X′.

10. A method according to claim 9 wherein it further comprises, upon training of each data synthesizer:
sampling M records for each data synthesizer,
concatenating the K sample of M records to form a new dataset X′.

11. A method according to claim 10 wherein it further comprises performing an inverted transformation to the dataset X′ regarding a transformation in which a dataset is transformed such that it has identity covariance and zero mean, thereby obtaining a transformed dataset X′_n, optionally applying an inverted Principal Component Analysis (PCA) methodology.

12. A method according to claim 11 wherein it further comprises performing an inverted transformation to the transformed dataset X′_n as regards a transformation to provide statistical independence between rows and/or statistical independence between columns, optionally applying an inverted Normalizing Flow methodology, optionally applying an inverted Rotation-based Iterative Gaussianization methodology.

13. A method according to claim 9 wherein the original dataset X may comprise any structured data and the new dataset X′ correspondingly comprises any structured data.

14. A computational apparatus or system configured to implement a computer implemented method for training a model comprising plurality of data synthesizers for data synthesis with enhanced scalability, the method comprising computationally performing the following steps:
providing a dataset X of M columns and N rows,
segmenting the N rows into segments of N/n rows, and slicing the M columns into slices of M/m columns,
combining each segment with a corresponding slice, thereby providing a providing a plurality of blocks, each block comprising a combination of a segment with a slice,
providing a model with K data synthesizers,
training each data synthesizer with a corresponding block,
wherein a transformation is performed to provide statistical independence between rows and/or statistical independency between columns of the dataset X and, optionally, additionally a method for generating a dataset X′ with enhanced scalability comprising:
training K data synthesizers, from a provided original dataset X, with a computer implemented method for training a model comprising plurality of data synthesizers for data synthesis with enhanced scalability, the method comprising computationally performing the following steps:
providing a dataset X of M columns and N rows,
segmenting the N rows into segments of N/n rows, and slicing the M columns into slices of M/m columns,
combining each segment with a corresponding slice, thereby providing a providing a plurality of blocks, each block comprising a combination of a segment with a slice,
providing a model with K data synthesizers,
training each data synthesizer with a corresponding block,
wherein a transformation is performed to provide statistical independence between rows and/or statistical independency between columns of the dataset X,
and
correspondingly generating a new dataset X′,
or
to implement a computer implemented method for generating a dataset X′ comprising:
training K data synthesizers, from a provided original dataset X, with a computer implemented method for training a model comprising plurality of data synthesizers for data synthesis with enhanced scalability, the method comprising computationally performing the following steps:
providing a dataset X of M columns and N rows,
segmenting the N rows into segments of N/n rows, and slicing the M columns into slices of M/m columns,
combining each segment with a corresponding slice, thereby providing a providing a plurality of blocks, each block comprising a combination of a segment with a slice,
providing a model with K data synthesizers,
training each data synthesizer with a corresponding block,
wherein a transformation is performed to provide statistical independence between rows and/or statistical independency between columns of the dataset X,
and
correspondingly generating a new dataset X′.

15. A computational apparatus or system according to claim 14 wherein the apparatus or system:
is configured to train the data synthesizers in parallel, and
comprises a plurality of computational processors, optionally K computational processors, each computational processor being configured to train at least one data synthesizer in parallel with another computational processor which is configured to train at least one other data synthesizer.
